(19) United States
(12) Patent Application Publication
(10) Pub. No.: US 2006/0201488 A1
(43) Pub. Date: Sep. 14, 2006

(54) Method for controlling a solenoid valve

(76) Inventors: Ekkehard Kohler, Adelberg (DE); Wolfgang Messerschmidt, Korntal (DE)

Correspondence Address: KLAUS J. BACH, 4407 TWIN OAKS DRIVE, MURRYSVILLE, PA, 15668, US

(21) Appl. No.: 11/401,018

(22) Filed: Apr. 6, 2006

Related U.S. Application Data
(63) Continuation-in-part of application No. PCT/EP04/10000, filed on Sep. 8, 2004.

(30) Foreign Application Priority Data
Oct. 7, 2003 (DE) 103 47 056.5

(51) Int. Cl. F02D 41/20; H01H 47/22

(52) U.S. Cl. 123/479; 123/490; 361/154

(57) ABSTRACT

In a method for controlling the opening and/or closing of a solenoid valve, wherein a profile of a current and/or a voltage applied to a coil of the solenoid valve is controlled in order to move a valve control element, a plurality of points in time of the opening and closing movement of the valve control element resulting from physical characteristic values of the current profile and/or solenoid valve are detected, and the time period between the detected points in time of the preceding opening and closing process is used as a control variable for controlling the current profile and/or voltage profile during the opening and closing process.

This is a Continuation-In-Part application of International Application PCT/EP2004/010000 filed Sep. 08, 2004 and claiming the priority of German Application 103 47 056.5 filed Oct. 07, 2003.

### BACKGROUND OF THE INVENTION

The invention relates to a method for controlling the opening and/or closing of a solenoid valve by controlling the profile of a current or voltage by which the solenoid is energized.

Such a method of controlling a solenoid valve is known from U.S. Pat. No. 6,292,345 B1. In said document, points in time of the opening and/or closing process are detected by means of threshold values and by determining the position of the armature of the solenoid valve.

A solenoid valve as known from DE 196 50 865 A1 is used to control the fuel pressure in the control pressure space of an injection valve, for example of an injector of a common rail injection system. In such injection valves, the movement of a valve piston with which an injection opening of the injection valve is opened or closed is controlled by means of the fuel pressure in the control pressure space. The known solenoid valve has an electromagnet which is arranged in a housing component, an axially movable armature which is guided in a slider element and acted on by a closing spring, and a control valve element which is moved with the armature and interacts with a valve seat of the solenoid valve and thus controls the discharge of fuel from the control pressure space.

A solenoid valve for controlling a fuel injection valve of an internal combustion engine is also known from DE 101 31 201 A1.

DE 196 07 073 A1 describes a method and a device for controlling the movement of an armature of an electromagnetic switching element (or of a solenoid valve) which has an exciter coil. In this context, beginning at a first point in time, a first setpoint value for the current can be provided and a second setpoint value for the current can be provided starting from a second point in time. The second setpoint value is smaller than the first setpoint value, and the second point in time is before a third point in time at which the armature with a solenoid valve needle or the control valve element reaches its end position.

It is known to determine the impact time of the armature by evaluating the current profile. Sensors or the like are also used for this purpose.

It is generally problematic that in the state of the art, the movement of the valve control element, that is the armature, has not been precisely controlled during the ballistic phase, that is to say during the movement phase of the valve control element. In particular the line resistance of the supply voltage is a factor which has a large adverse effect on the movement or flight phase because a high internal resistance can lead to voltage fluctuations. Since the voltage is generally measured by forming average values, dips in the voltage as a result of the internal resistance can hardly be detected. But precise current control at every discrete point in time is very costly since, for example, a separate processor would have to be made available for this purpose. However, as a result of these voltage fluctuations, the attraction time and impact time of the armature or of the valve control element change, as a result of which it is disadvantageously impossible to precisely reproduce a closing process or the flight or movement phase of the armature. This is problematic in particular when there are precise requirements, for example when controlling the fuel injection in an internal combustion engine, since the physical start of the injection takes place in each case at a different point in time from the point in time as planned. This leads to changes in the quantity of fuel injected into the cylinder, which in turn leads to an undesired change in the engine torque.

It is the object of the present invention to provide a method of controlling the opening and/or closing process of a solenoid valve of the type mentioned above which eliminates the disadvantages of the prior art and provides for a reproducible opening and/or closing of a solenoid valve.

### SUMMARY OF THE INVENTION

In a method for controlling the opening and/or closing of a solenoid valve, wherein a profile of a current and/or a voltage applied to a coil of the solenoid valve is controlled in order to move a valve control element, a plurality of points in time of the opening and closing movement of the valve control element resulting from physical characteristic values of the current profile and/or solenoid valve are detected, and the time period between the detected points in time of the preceding opening and closing process is used as a control variable for controlling the current profile and/or voltage profile during the opening and closing process.

Since the time period between certain points in time of the preceding opening and/or closing process is used as a controlled variable for controlling the current profile and/or voltage profile for the opening and/or closing process, the current profile can advantageously be set precisely. In particular, during the closing process of the solenoid valve, the attraction time and impact time of the armature or of the control valve element are already sensed, as a result of which, by correspondingly adapting the current and voltage profiles, the flight phase phase of the control valve element or of the armature can easily be controlled using these values which are already available. As a result, the flight phase of the control valve element can be reproduced up to the impact time and no complex control of the current value needs to be carried out at any discrete point in time. As a result, production costs can be kept low.

In particular it is possible to sense when the attraction phase of the control valve element is past (for example when a current threshold value is exceeded), and, as is known, it is also possible to sense the impact time. The overall duration of the flight phase of the armature can be calculated with these variables. As a result, it is possible to determine in a precisely reproducible fashion how long the attraction phase with a high voltage for acceleration of the armature lasts, how long the following second phase with a lower voltage, after a current threshold value has been exceeded, up to the impact (closing of the solenoid valve) lasts, and how long the holding phase after the impact time lasts.

When the control is used in an internal combustion engine to control an injection process, it is possible in this way to obtain a constant time behavior of the solenoid valves and as a result of this a reproducible physical start of injection for the injection process. As a result, the quantity of fuel which is injected into the cylinders remains constant, as does the engine torque. In addition, series-production variations of solenoid valves can be compensated by this actuation or control process. The mechanical and electrical tolerances of the plug-in pumps which are frequently used for the injection process are taken into account and compensated.

Advantageous refinements and developments of the invention will become apparent from the following description of an exemplary embodiment with reference to the accompanying drawings:

### BRIEF DESCRIPTION OF THE DRAWINGS

FIG. 1 shows a current diagram during the closing process of a solenoid valve when there is increased internal resistance of the supply lines with and without a control process according to the invention; and

FIG. 2 shows a flowchart of an embodiment of the control process according to the invention.

### DESCRIPTION OF AN EXEMPLARY EMBODIMENT

It is known to use a solenoid valve (not illustrated here) to control the injection of fuel in an internal combustion engine, for example from DE 196 07 073 A1. An exciter winding or coil of the solenoid valve is arranged in series with a voltage source and at least one controllable switching means, for example a transistor, which is actuated by an open-loop and closed-loop control unit in accordance with a control signal. The control signal is provided by an engine controller.

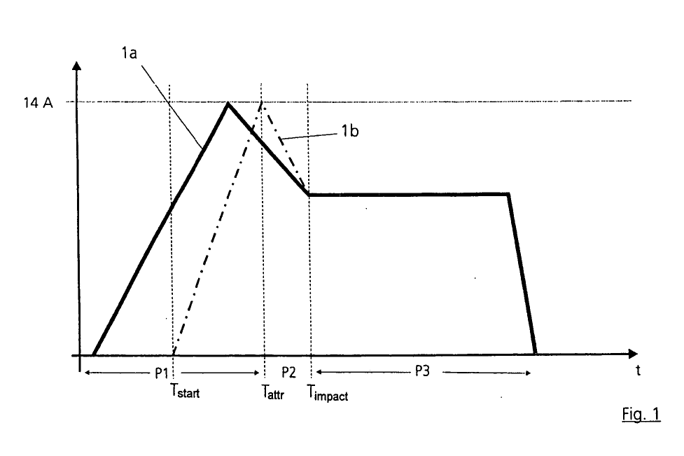

The present exemplary embodiment shows a method for controlling an opening and/or closing process of the solenoid valve, wherein, during the closing process of the solenoid valve when fuel is to be injected into the internal combustion engine, the voltage source supplies the exciter winding with a voltage in three phases P1, P2, P3 (see FIG. 1). The voltage varies in each phase P1, P2, P3, as a result of which a control valve element is correspondingly moved, in particular by means of an armature. In other exemplary embodiments, the voltage can, for example, also be modulated in different ways in the respective phases.

In the first phase, which is the attraction phase of the control valve element or of the armature of the solenoid valve, a first voltage is applied at the point in time Tₛₜₐᵣₜ until a current threshold value, labeled as 14 amps in the present exemplary embodiment, is reached. As a result, the control valve element starts to move or is accelerated. After the attraction time Tₐₜₜᵣ (i.e. the current threshold value) is reached, the voltage is reduced again in phase P2 in order to avoid accelerating the armature or the control valve element further. After the control valve element impacts at the point in time T_{impact} in the phase P3, the voltage is kept constant in order to hold the control valve in the impact state, that is, to keep the solenoid valve closed.

FIG. 1 outlines a current profile curve 1a without timed control of the phases P1 and P2. A dash-dotted curve 1b shows a current profile of the solenoid valve for nominal conditions or with an adjustment over time according to the invention, in particular of the phases P1 and P2, by means of the detected points in time Tₛₜₐᵣₜ, Tₐₜₜᵣ and T_{impact}.

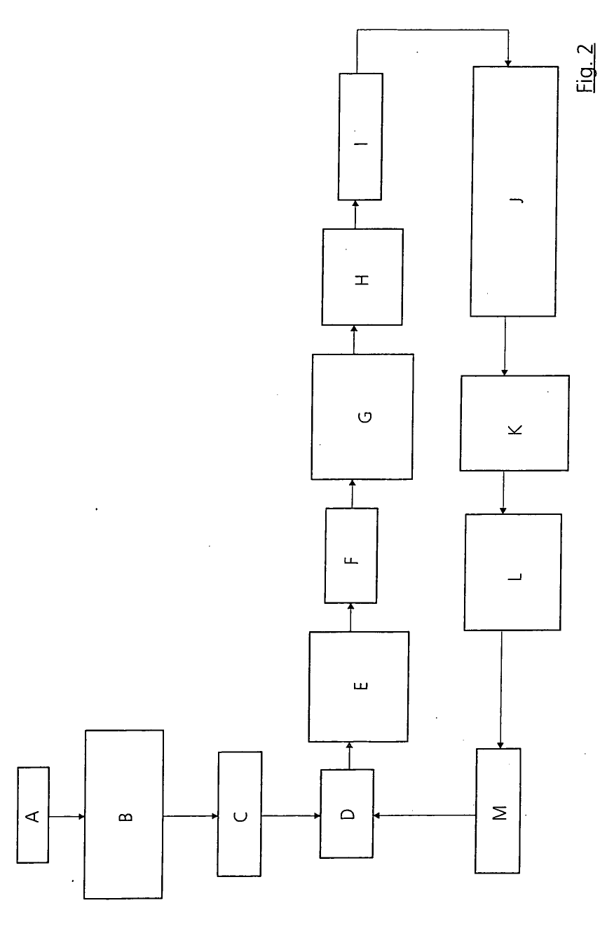

FIG. 2 illustrates a control method according to the invention in the form of a flowchart. Here, a step A characterizes the start of the method, and the start values for the voltage ratios in phases P1 and P2 are defined in a step B. In a step C, the start of the supply of current to the solenoid valve takes place at the point in time Tₛₜₐᵣₜ. Then, the corresponding voltage is applied for the phase P1 (step D). In a step E, the detection of attraction, i.e. the measurement of the point in time Tₐₜₜᵣ is carried out by means of the fact that the current value threshold is reached, after which in a step F the phase P2 is initiated by applying a further, modified voltage. In a step G, the detection of impact follows, i.e. the measurement of the impact time T_{impact}, after which the phase P3 is initiated at a point H. In the present exemplary embodiment, this phase P3 is characterized by precise current control and represents what is referred to as the holding phase of the solenoid valve. This is followed, in a step I, by the rapid switching off of the voltage or opening of the solenoid valve. In a step J, the duration of the flight phase of the control valve element T_{flight}=T_{impact}−Tₐₜₜᵣ is calculated and this is used to control new voltage ratios for the phases P1 and P2 in a step K, and to determine said ratios in a step L, after which a renewed start of the supply of current with the new voltage ratios can occur again in step D in order to constantly adjust Tₐₜₜᵣ and T_{impact}. The resulting time behavior of the current profile consequently continues to have the required precision, as does the injection behavior of the internal combustion engine which is then constant irrespective of mechanical and hydraulic interference variables. The solution can easily be implemented by means of a computer program. Automatic compensation of aging effects and fabrication variations of the solenoid valves is additionally achieved. The flight time of the control valve element can be used for diagnosing the internal combustion engine.

The constant attraction and impact times Tₐₜₜᵣ, T_{impact} of the valve cause the respective physical start of injection to remain constant, and thus also the quantity of fuel injected into the cylinders since the injection nozzle is always subjected to a uniform pressure.

What is claimed is:

1. A method of controlling an opening and closing process of a solenoid valve by controlling a profile of at least one of a current and a voltage applied to a coil of the solenoid valve in order to move a valve control element, wherein a plurality of points in time of the opening and/or closing process are detected including the points in time of the opening and closing process resulting from physical characteristic values of the current profile, said method comprising the steps of:
using the time period between the detected points in time (Tₛₜₐᵣₜ, Tₐₜₜᵣ, T_{impact}) of the preceding opening and closing process as a control variable for controlling at least one of the current profile and voltage profile during the opening and closing process, the control taking place during a flight phase of the control valve element between a first detected point in time (Tₛₜₐᵣₜ) which marks the start of the supply of current or voltage to the coil in order to attract the valve control element of the solenoid valve, and a third detected point in time (T_{impact}) which marks the impact of the valve control element.

2. The method as claimed in claim 1, wherein a second detected point in time (Tₐₜₜᵣ) marks the end of the attraction phase after a current threshold value has been reached, and the start of the impact phase of the valve control element of the solenoid valve.

3. The method as claimed in claim 1, wherein the third detected point in time (T_{impact}) marks the impact of the valve control element when the solenoid valve closes.

4. The method as claimed in claim 1, wherein the method is used for controlling the injection of fuel in an internal combustion engine.

5. The method as claimed in claim 4, wherein the control variable is used as the diagnostic value for the internal combustion engine.
